(19) United States
(12) Patent Application Publication
(10) Pub. No.: US 2026/0241508 A1
(43) Pub. Date: Aug. 20, 2026

(54) POWER TOOL SYSTEM WITH MITER GAUGE

(71) Applicant: Robert Bosch GmbH, Stuttgart (DE)

(72) Inventor: Andrew Frolov, Glenview, IL (US)

(21) Appl. No.: 19/069,364

(22) Filed: Mar. 4, 2025

Related U.S. Application Data
(60) Provisional application No. 63/760,351, filed on Feb. 19, 2025.

(51) Int. Cl. B23Q 16/06; B27B 5/22; B27B 25/10

(52) U.S. Cl. CPC B23Q 16/06; B27B 5/222; B27B 25/10

(57) ABSTRACT

A device may include a workpiece support surface. A device may include a guide slot opening to the workpiece support surface. A device may include a miter gauge including a guide assembly configured to be positioned at least partially within the guide slot, and a fence portion operably connected to the guide assembly, wherein. A device may include the guide assembly includes a main body, an adjustment body, a set screw, and a fastener. A device may include the set screw is configured to position the adjustment body laterally with respect to the main body. A device may include the fastener is configured to fasten the adjustment body to the main body.

This application claims benefit to provisional application No. 62/760,351, filed on Feb. 25, 2025, the disclosure of which is incorporated herein by reference in its entirety.

### FIELD

The present disclosure relates generally to power tools, and more particularly, to power tool systems incorporating miter gauges.

### BACKGROUND

A number of power tools have been produced to facilitate forming a workpiece into a desired shape. In many power tools, a table is provided to support a workpiece which is then maneuvered with respect to a working tool such as a blade, a sanding device, a router, etc. so as to shape the workpiece.

To provide accuracy in the shaping of the workpiece, it is known to provide a mechanism for positioning the workpiece on a workpiece support surface. One such mechanism is a miter gauge. A miter gauge is a tool which typically allows for a specific angle to be set between the workpiece and the working tool. The miter gauge is then used to move the workpiece with the preset angle into contact with the working tool. For example, miter gauges typically include a guide member which is positioned within a slot formed in the table which provides the workpiece support surface. The guide member is moved along the slot to place the workpiece in contact with the working tool.

While effective, the above-described miter gauge has some shortcomings. For example, manufacturing tolerances result in a mismatch between the width of the slot and the width of the miter gauge guide member. Consequently, play is introduced between the miter gauge and the slot resulting in errors introduced into the work product since the guide member shifts within the slot as the workpiece is moved into contact with the working tool. Additional play can be introduced by differences in finishing processes, such as painting, between different units. Furthermore, as a guide member is moved within a slot both the slot and the guide member become worn introducing additional play into the system.

In response to the inaccuracies introduced by known miter gauge systems, adjustable miter gauge systems have been developed. These systems allow the width of a miter gauge guide member to be specifically adjusted to the width of the slot of a specific table. While effective in reducing mismatches between the width of a slot in a table and the width of the miter gauge guide member, these solutions are very expensive.

Consequently, there is a need for a low-cost miter gauge that is capable of providing highly accurate cross-cuts and that can significantly increase cutting capacity.

### SUMMARY

In some aspects, the techniques described herein relate to a power tool system, including a workpiece support surface, a guide slot opening to the workpiece support surface, and a miter gauge including a guide assembly configured to be positioned at least partially within the guide slot, and a fence portion operably connected to the guide assembly. The guide assembly includes a main body, an adjustment body, a set screw, and a fastener. The set screw is configured to position the adjustment body laterally with respect to the main body, and the fastener is configured to fasten the adjustment body to the main body.

In one or more embodiments of a power tool system the main body includes an upper main body surface, an activation surface extending downwardly from the upper main body surface, and a support surface extending laterally away from the activation surface, the support surface parallel to the upper main body surface. The adjustment body includes an upper adjustment body surface, and a slide surface opposite the upper adjustment body surface and supported by the support surface.

In one or more embodiments of a power tool system the adjustment body includes a positioning bore opening to the upper adjustment body surface and to a side surface of the adjustment body. The side surface extends between the upper adjustment body surface and the slide surface. The positioning bore defines an adjustment axis which intersects the activation surface. The set screw is configured to threadedly engage the positioning bore and to extend outwardly from the positioning bore along the adjustment axis into contact with the activation surface.

In one or more embodiments of a power tool system the adjustment body includes a fastening bore elongated along the adjustment axis, the fastening bore opening to the upper adjustment body surface and opening to the slide surface. The main body includes a base bore opening to the support surface and aligned with the fastening bore. The fastener is threadedly engaged with the base bore and configured to clamp the adjustment body to the main body.

In one or more embodiments of a power tool system the guide slot is as T-shaped guide slot including two downwardly facing guide surface. The main body includes two upwardly facing guide surfaces. The two upwardly facing guide surfaces are configured to be in opposition to the two downwardly facing guide surfaces when the guide assembly is positioned at least partially within the guide slot.

In one or more embodiments of a power tool system a pivot extends through the fence portion and is mounted to the main body. The pivot is configured to permit pivoting of the fence portion with respect to the main body while the adjustment body is fastened to the main body by the fastener.

In one or more embodiments of a power tool system the fence portion further includes a lock handle configured to selectively lock the fence portion to the main body to prevent pivoting of the fence portion with respect to the main body. The lock handle is configured to permit sliding of the slide surface on the support surface while the fence portion is selectively locked to the main body.

In one or more embodiments a miter gauge system includes a guide assembly configured to be positioned at least partially within a guide slot of a power tool, and a fence portion operably connected to the guide assembly. The guide assembly includes a main body, an adjustment body, a set screw, and a fastener. The set screw is configured to position the adjustment body laterally with respect to the main body, and the fastener is configured to fasten the adjustment body to the main body.

In one or more embodiments of the miter gauge system the main body includes an upper main body surface, an activation surface extending downwardly from the upper main body surface, and a support surface extending laterally away from the activation surface. The support surface is parallel to the upper main body surface. The adjustment body includes an upper adjustment body surface, and a slide surface opposite the upper adjustment body surface and supported by the support surface.

In one or more embodiments of the miter gauge system the adjustment body includes a positioning bore opening to the upper adjustment body surface and to a side surface of the adjustment body. The side surface extends between the upper adjustment body surface and the slide surface. The positioning bore defines an adjustment axis which intersects the activation surface. The set screw is configured to threadedly engage the positioning bore and to extend outwardly from the positioning bore along the adjustment axis into contact with the activation surface.

In one or more embodiments of the miter gauge system the adjustment body includes a fastening bore elongated along the adjustment axis, the fastening bore opening to the upper adjustment body surface and opening to the slide surface. The main body includes a base bore opening to the support surface and aligned with the fastening bore. The fastener is threadedly engaged with the base bore and configured to clamp the adjustment body to the main body.

In one or more embodiments of the miter gauge system the main body includes two upwardly facing guide surfaces and the two upwardly facing guide surfaces are configured to be in opposition to two downwardly facing guide surfaces of a T-shaped guide slot when the guide assembly is positioned at least partially within the guide slot.

In one or more embodiments of the miter gauge system a pivot extends through the fence portion and is mounted to the main body. The pivot is configured to permit pivoting of the fence portion with respect to the main body while the adjustment body is fastened to the main body by the fastener.

In one or more embodiments of the miter gauge system the fence portion further includes a lock handle configured to selectively lock the fence portion to the main body to prevent pivoting of the fence portion with respect to the main body. The lock handle is configured to permit sliding of the slide surface on the support surface while the fence portion is selectively locked to the main body.

### BRIEF DESCRIPTION OF THE DRAWINGS

The above-described features and advantages, as well as others, will become more readily apparent to those of ordinary skill in the art by reference to the following detailed description and accompanying drawings.

FIG. 1 depicts a side perspective view of a power tool system in the form of a table saw.

FIG. 2 depicts the miter gauge of the power tool system of FIG. 1 including a fence portion and a guide assembly.

FIG. 3 depicts a cross-sectional view of the guide assembly of FIG. 2 positioned within the slot of the power tool system of FIG. 1.

FIG. 4 depicts a cross-sectional view of the guide assembly of FIG. 2.

FIG. 5 depicts a partial schematic representation of a top plan view of the guide assembly of FIG. 2.

FIG. 6, depicts a cross-sectional view of the guide assembly of FIG. 2 taken along the line A-A of FIG. 5 showing an elongated fastener bore including a counter sink portion, a clamping shoulder, and a neck portion. A base bore opening to the support surface of the main body is also shown.

FIG. 7 depicts a cross-sectional view of the guide assembly of FIG. 2 taken along the line B-B of FIG. 5 showing a positioning bore with a positioning axis aligned with an activation surface of the main body.

FIG. 8 depicts side plan views of a fastener and a set screw used with the guide assembly of FIG. 2.

FIG. 9 depicts a side cross-sectional view of the guide assembly of FIG. 2 positioned within the slot of the power tool system of FIG. 1 with the adjustment body unlocked and spaced apart from a side guide surface of the slot.

FIG. 10 depicts a side cross-sectional view of the guide assembly of FIG. 2 positioned within the slot of the power tool system of FIG. 1 with the adjustment body spaced apart from a side guide surface of the slot with the set screw contacting the activation surface of the main body.

FIG. 11 depicts a partial side cross-sectional view of the guide assembly of FIG. 2 positioned within the slot of the power tool system of FIG. 1 with the adjustment body unlocked and contacting the side guide surface of the slot.

FIG. 12 depicts a partial side cross-sectional view of the guide assembly of FIG. 2 positioned within the slot of the power tool system of FIG. 1 with the adjustment body contacting the side guide surface of the slot and with the set screw contacting the activation surface of the main body.

FIG. 13 depicts a side cross-sectional view of the guide assembly of FIG. 2 positioned within the slot of the power tool system of FIG. 1 with the adjustment body locked and in contact with the side guide surface of the slot.

FIG. 14 depicts a side cross-sectional view of the guide assembly of FIG. 2 positioned within the slot of the power tool system of FIG. 1 with the adjustment body contacting the side guide surface of the slot and with the set screw contacting the activation surface of the main body.

FIG. 15 depicts a partial cross-sectional view of the pivot connection between the fence portion and the guide assembly of the fence portion of FIG. 2.

FIG. 16 depicts a partial cross-sectional view of the lock handle connection with the main body of the guide assembly of FIG. 2.

### DETAILED DESCRIPTION

For the purpose of promoting an understanding of the principles of the disclosure, reference will now be made to the embodiments illustrated in the drawings and described in the following written description. It is to be understood that no limitation to the scope of the disclosure is thereby intended. It is further to be understood that the present disclosure includes any alterations and modifications to the illustrated embodiments and includes further applications of the principles of the disclosure as would normally occur to one skilled in the art to which this disclosure pertains.

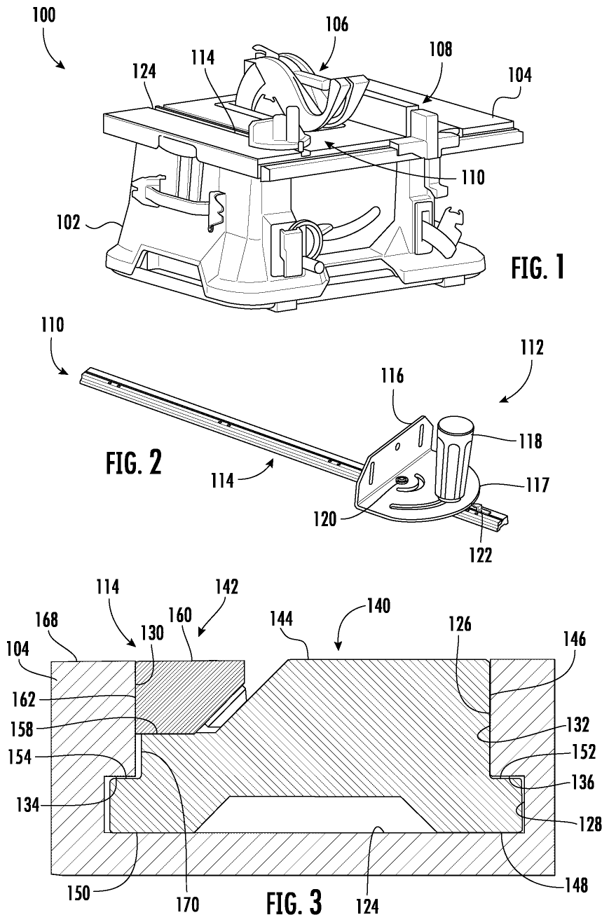

FIG. 1 depicts a power tool system 100 in the form of a table saw. The power tool system 100 includes a base portion 102 and a workpiece support table 104. The workpiece support table 104 is configured to support a workpiece upon which a working tool 106, which in the embodiment of FIG. 1 is a circular saw blade but in other embodiments is a grinding device, router, or the like, performs a process. A guide fence 108 is positioned on one side of the working tool 106 while a miter gauge 110 is provided on the opposite side of the working tool 106.

The miter gauge 110, also shown in FIG. 2, includes a fence portion 112 and a guide assembly 114. The fence portion 112 includes a fence 116 which extends upwardly from a base portion 117 and a lock handle 118. The fence portion 112 is pivotably connected to the guide assembly 114 by a pivot 120. The pivot 120 allows the fence 116 to be set at an angle with respect to the guide assembly 114. The angle is identified by an angle indicator 122 while the lock handle 118 is used to lock the fence 116 at the desired angle as discussed in further detail below.

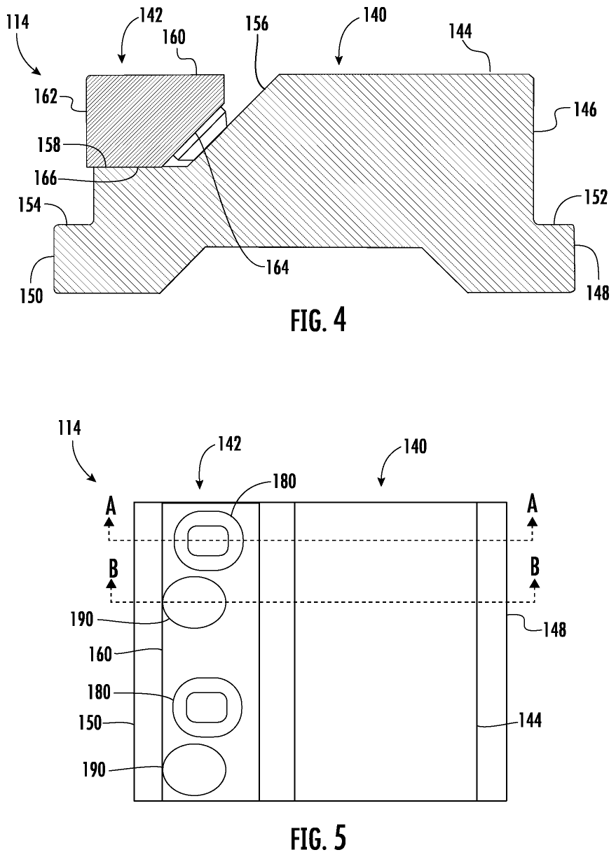

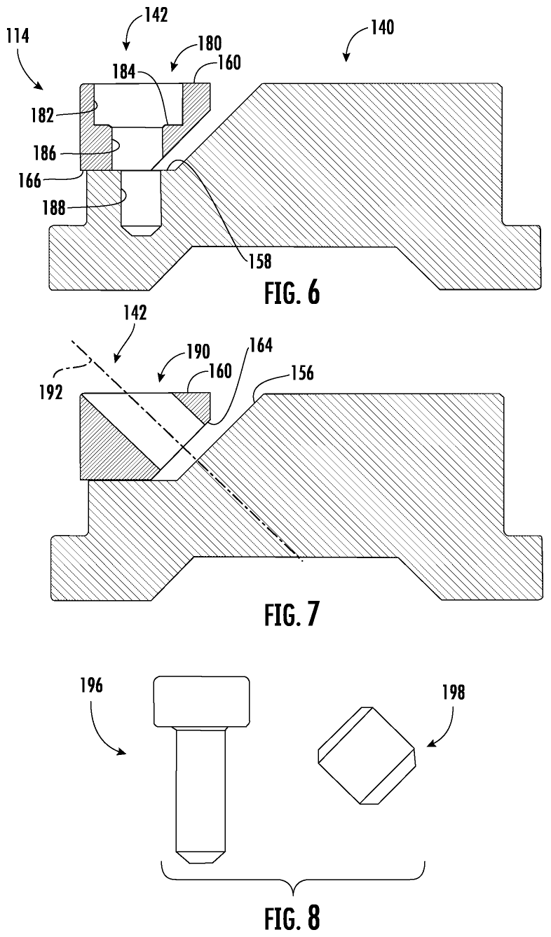

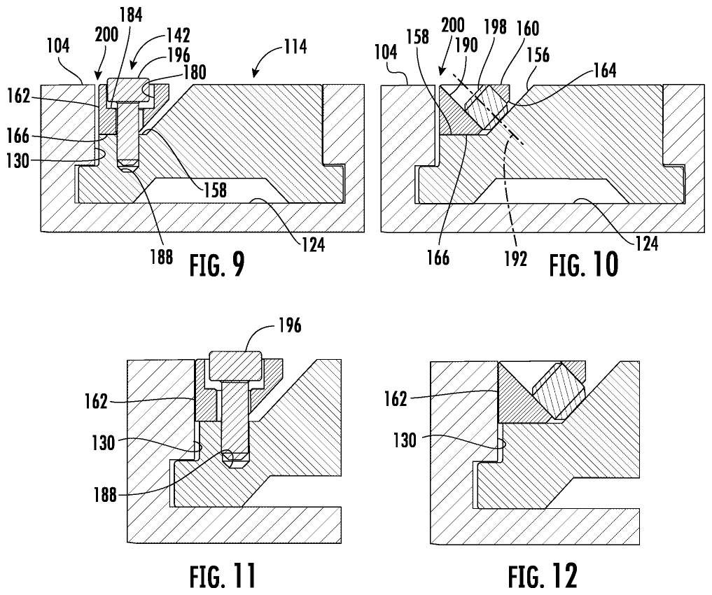

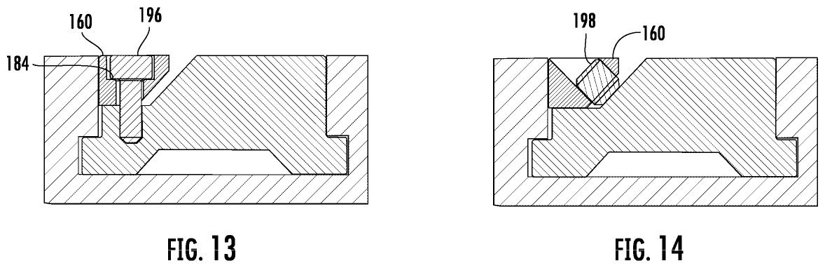

The guide assembly 114 is configured to be positioned at least partially within a slot 124 in the workpiece support table 104 as shown in FIG. 3. The slot 124 is a T-shaped slot in the embodiment of FIG. 3 and includes a neck portion 126 and a head portion 128. The neck portion 126 includes a side guide surface 130 and a side guide surface 132. The head portion 128 of the slot 124 includes a downwardly facing guide surface 134 and a downwardly facing guide surface 136.

The guide assembly 114 includes a main body 140 and an adjustment body 142. With reference to FIG. 4, the main body 140 includes an upper planar surface 144, a side guide surface 146, a foot 148 and a foot 150. The foot 148 defines an upwardly facing guide surface 152 and the foot 150 defines an upwardly facing guide surface 154. An activation surface 156 extends downwardly from the upper planar surface 144 to a laterally extending support surface 158. The laterally extending support surface 158 is parallel to the upper planar surface 144.

The adjustment body 142 includes an upper planar surface 160 and a side guide surface 162. A side surface 164 faces the activation surface 156 while a slide surface 166 is positioned on the laterally extending support surface 158. The guide assembly 114 and the slot 124 are configured such that when the guide assembly 114 is positioned within the slot 124, the upper planar surface 144 and the upper planar surface 160 are coplanar with a workpiece support surface 168 of the workpiece support table 104 as shown in FIG. 3. In some embodiments, one or both of the upper planar surface 144 and the upper planar surface 160 are configured to be slightly lower than the workpiece support surface 168. In some embodiments, the upper planar surface 160 is configured to be lower than the upper planar surface 144.

Turning to FIG. 3, the foot 148 and the foot 150 are positioned within the head portion 128 with the upwardly facing guide surface 152 and upwardly facing guide surface 154 facing the downwardly facing guide surface 136 and the downwardly facing guide surface 134, respectively. The width of the main body 140 from the side guide surface 146 to the opposite side of the laterally extending support surface 158 is slightly less than the width of the neck portion 126. Consequently, when the side guide surface 146 is in contact with the side guide surface 132, a small gap 170 is provided adjacent the laterally extending support surface 158. The side guide surface 162 of the guide assembly guide assembly 114, however, is in sliding contact with the side guide surface 130 due to the further configuration of the guide assembly 114 discussed with initial reference to FIG. 5.

FIG. 5 is a schematic representation of a portion of the upper planar surface 144 and the upper planar surface 160 of the guide assembly 114. A number of elongated fastener bores 180 and positioning bores 190 open to the upper planar surface 160. As shown in FIG. 6, which is a cross-sectional view of the guide assembly 114 taken along the line A-A of FIG. 5, the elongated fastener bores 180 include a counter sink portion 182, a clamping shoulder 184, and a neck portion 186. The elongated fastener bores 180 extend from the upper planar surface 160 to the slide surface 166 and are generally aligned with a base bore 188 in the laterally extending support surface 158.

FIG. 7 is a cross-sectional view of the guide assembly 114 taken along the line B-B of FIG. 5. As shown in FIG. 7, a positioning bore 190 extends from the upper planar surface 160 to the side surface 164 and defines an adjustment axis 192 which extends through the activation surface 156.

The elongated fastener bores 180, the base bores 188, and the positioning bores 190, along with fasteners 196 and set screws 198 shown in FIG. 8, allow the adjustment body 142 to be adjusted such that the side guide surface 162 is positioned against the side guide surface 130 when the guide assembly 114 is positioned within the slot 124. Adjustment to provide this configuration is described with initial reference to FIGS. 9 and 10.

As shown in FIGS. 9 and 10, the guide assembly 114 is initially positioned within the slot 124 with the fastener 196 positioned within an elongated fastener bore 180 and the base bore 188. The set screw 198 is positioned within the positioning bore 190 with the set screw 198 optionally in contact with the activation surface 156. Regardless of whether the set screw 198 is in contact with the activation surface 156, since the positioning bore 190 is configured such that the adjustment axis 192 is aligned with the activation surface 156, the set screw 198 is likewise aligned with the activation surface 156.

The configuration of FIGS. 9 and 10 further shows that a gap 200 is present between the side guide surface 162 and the side guide surface 130. By rotation of the set screw 198, which is accessible through the upper planar surface 160, the set screw 198 which is threadedly engaged with the positioning bore 190 presses against the activation surface 156 generating a force in the direction toward the side guide surface 130. Because the fastener 196 is not in clamping contact with the clamping shoulder 184, the slide surface 166 of the adjustment body 142 is forced to slide across the laterally extending support surface 158 until the side guide surface 162 contacts the side guide surface 130 as shown in FIGS. 11 and 12. The user then rotates the fastener 196 which is threadedly engaged with the base bore 188 until the fastener 196 contacts the clamping shoulder 184 as shown in FIG. 13 thereby locking the adjustment body 142 to the main body 140. As shown in FIGS. 13 and 14, in the locked position the uppermost portions of both the fastener 196 and the set screw 198 are positioned at or beneath the upper planar surface 160.

The above process is repeated for each of the fastener 196 and set screw 198 thereby providing a snug fit along the entire length of the guide assembly 114 in the slot 124.

The disclosed system provides a main body with an angular activation surface 156, while thrusting set-screws are located in the adjustment body 142. In some embodiments, the fastener 196 and the set screw 198 are configured to not be removable from the adjustment body 142 by a user.

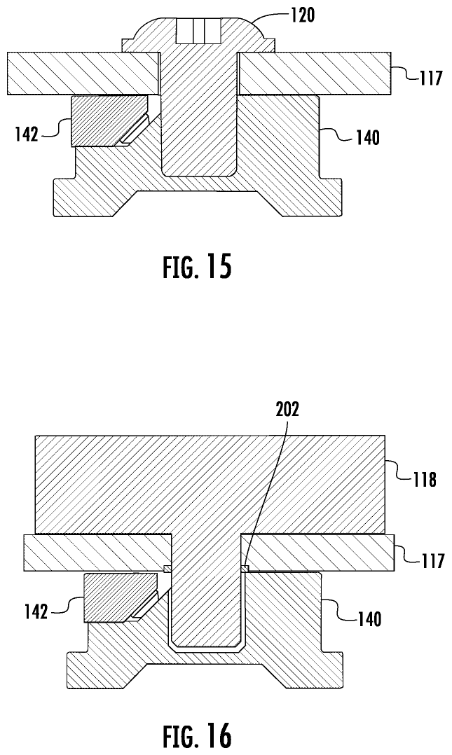

Moreover, since the adjustment body 142 slides horizontally on the laterally extending support surface 158, the adjustment body 142 and the fence portion 112 can be adjusted without impact on the other of the adjustment body 142 and the fence portion 112 as described with respect to FIGS. 15 and 16. As shown in FIG. 15, the pivot 120 is attached to the main body 140. Thus, neither movement of the adjustment body 142 nor pivoting of the base portion 117 is impeded by the other of the adjustment body 142 and base portion 117.

Likewise, as shown in FIG. 16, the lock handle 118 is attached solely to the main body 140. Thus, even with the lock handle 118 clamping the base portion 117 to the main body 140, movement of the adjustment body 142 is not impeded. In some embodiments, a clamp ring 202 is provided to ensure minimal spacing between the base portion 117 and the adjustment body 142 when the base portion 117 is clamped by the lock handle 118.

The above-described system thus provides a miter gauge which is easily adjustable to exact T-slot dimensions eliminating side gap and angular inconsistency during cross cuts. The disclosed system accounts for inconsistent T-slot dimensions resulting from manufacturing tolerances and finishing variances (e.g., painting). The system provides for continuous contact with slot walls on both sides while avoiding incremental adjustments. The system thus provides for highly accurate cross cuts which are difficult to achieve with standard miter gauges. Moreover, the system provides easily accessible adjustment mechanisms allowing for precise adjustment while the miter gauge is positioned within a slot.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

We claim:

1. A power tool system, comprising:
a workpiece support surface;
a guide slot opening to the workpiece support surface; and
a miter gauge including
a guide assembly configured to be positioned at least partially within the guide slot, and
a fence portion operably connected to the guide assembly,
wherein
the guide assembly includes a main body, an adjustment body, a set screw, and a fastener,
the set screw is configured to position the adjustment body laterally with respect to the main body, and
the fastener is configured to fasten the adjustment body to the main body.

2. The power tool system of claim 1, wherein:
the main body includes an upper main body surface, an activation surface extending downwardly from the upper main body surface, and a support surface extending laterally away from the activation surface, the support surface parallel to the upper main body surface; and
the adjustment body includes an upper adjustment body surface, and a slide surface opposite the upper adjustment body surface and supported by the support surface.

3. The power tool system of claim 2, wherein:
the adjustment body includes a positioning bore opening to the upper adjustment body surface and to a side surface of the adjustment body;
the side surface extends between the upper adjustment body surface and the slide surface;
the positioning bore defines an adjustment axis which intersects the activation surface; and
the set screw is configured to threadedly engage the positioning bore and to extend outwardly from the positioning bore along the adjustment axis into contact with the activation surface.

4. The power tool system of claim 3, wherein:
the adjustment body includes a fastening bore elongated along the adjustment axis, the fastening bore opening to the upper adjustment body surface and opening to the slide surface;
the main body includes a base bore opening to the support surface and aligned with the fastening bore; and
the fastener is threadedly engaged with the base bore and configured to clamp the adjustment body to the main body.

5. The power tool system of claim 4, wherein:
the guide slot is as T-shaped guide slot including two downwardly facing guide surfaces;
the main body includes two upwardly facing guide surfaces; and
the two upwardly facing guide surfaces are configured to be in opposition to the two downwardly facing guide surfaces when the guide assembly is positioned at least partially within the guide slot.

6. The power tool system of claim 4, further comprising:
a pivot extending through the fence portion and mounted to the main body,
wherein the pivot is configured to permit pivoting of the fence portion with respect to the main body while the adjustment body is fastened to the main body by the fastener.

7. The power tool system of claim 6, the fence portion further comprising:
a lock handle configured to selectively lock the fence portion to the main body to prevent pivoting of the fence portion with respect to the main body,
wherein the lock handle is configured to permit sliding of the slide surface on the support surface while the fence portion is selectively locked to the main body.

8. A miter gauge system, comprising:
a guide assembly configured to be positioned at least partially within a guide slot of a power tool; and
a fence portion operably connected to the guide assembly,
wherein
the guide assembly includes a main body, an adjustment body, a set screw, and a fastener,
the set screw is configured to position the adjustment body laterally with respect to the main body, and
the fastener is configured to fasten the adjustment body to the main body.

9. The miter gauge system of claim 8, wherein:
the main body includes an upper main body surface, an activation surface extending downwardly from the upper main body surface, and a support surface extending laterally away from the activation surface, the support surface parallel to the upper main body surface; and
the adjustment body includes an upper adjustment body surface, and a slide surface opposite the upper adjustment body surface and supported by the support surface.

10. The miter gauge system of claim 9, wherein:
the adjustment body includes a positioning bore opening to the upper adjustment body surface and to a side surface of the adjustment body;
the side surface extends between the upper adjustment body surface and the slide surface;
the positioning bore defines an adjustment axis which intersects the activation surface; and
the set screw is configured to threadedly engage the positioning bore and to extend outwardly from the positioning bore along the adjustment axis into contact with the activation surface.

11. The miter gauge system of claim 10, wherein:
the adjustment body includes a fastening bore elongated along the adjustment axis, the fastening bore opening to the upper adjustment body surface and opening to the slide surface;
the main body includes a base bore opening to the support surface and aligned with the fastening bore; and
the fastener is threadedly engaged with the base bore and configured to clamp the adjustment body to the main body.

12. The miter gauge system of claim 11, wherein:
the main body includes two upwardly facing guide surfaces; and
the two upwardly facing guide surfaces are configured to be in opposition to two downwardly facing guide surfaces of a T-shaped guide slot when the guide assembly is positioned at least partially within the guide slot.

13. The miter gauge system of claim 11, further comprising:
a pivot extending through the fence portion and mounted to the main body,
wherein the pivot is configured to permit pivoting of the fence portion with respect to the main body while the adjustment body is fastened to the main body by the fastener.

14. The miter gauge system of claim 13, the fence portion further comprising:
a lock handle configured to selectively lock the fence portion to the main body to prevent pivoting of the fence portion with respect to the main body,
wherein the lock handle is configured to permit sliding of the slide surface on the support surface while the fence portion is selectively locked to the main body.
